(19) United States
(12) Patent Application Publication
(10) Pub. No.: US 2007/0187050 A1
(43) Pub. Date: Aug. 16, 2007

(54) MODULAR PARTITION DECORATION SYSTEM AND METHOD

(76) Inventor: James C. Jensen, Long Branch, NJ (US)

Correspondence Address: GREENBERG TRAURIG, LLP, MET LIFE BUILDING, 200 PARK AVENUE, NEW YORK, NY, 10166, US

(21) Appl. No.: 11/673,688

(22) Filed: Feb. 12, 2007

Related U.S. Application Data
(60) Provisional application No. 60/772,676, filed on Feb. 13, 2006.

(51) Int. Cl. E05D 15/06

(52) U.S. Cl. 160/196.1; 160/405

(57) ABSTRACT

In one embodiment of the present invention a modular partition decoration system comprises interconnecting segments which may be assembled to provide a decorative feature that spans the distance between two opposing surfaces, such as walls, and facilitates concealment of partition hardware therebetween, such as, for example, decoratively concealing a shower curtain rod.

### RELATED APPLICATIONS

This application claims the benefit of U.S. Provisional Application Ser. No. 60/772,676, filed Feb. 13, 2006, which is incorporated herein by reference in its entirety.

### FIELD OF THE INVENTION

One embodiment of the present invention relates to a modular system for use in decorating partitions that separate physical spaces. In one example, the present invention relates to a modular system having interconnecting segments which may be assembled to provide a decorative feature that spans the distance between two opposing surfaces (e.g., walls). In another example, various embodiments of the present invention facilitate concealment of partition hardware, such as, for example, decoratively concealing a shower curtain rod.

### BACKGROUND OF THE INVENTION

Partitions are typically established to separate one physical space from another. Such partitions may take the form of curtains, such as, for example, a shower curtain in a bathroom, or a curtain in a passageway used to separate two rooms.

Typically such curtains are suspended from a cross-member that spans the length between two opposing surfaces, such as the walls of a bathroom. This cross member may be in the form of a rod, and the rod may have any common cross-sectional shape that suits it's particular application. For example, shower curtain rods typically have round cross-sections and ends.

In utilizing partitions, there may be a desire to decorate them to enhance the overall decor of the surrounding environment. For example, in addition to mounting one curtain on a cross-member in order to separate two spaces, drapes may also be mounted on either side of that curtain to increase the aesthetics of the partition. Additionally, there may also be a desire to conceal and/or decorate the cross-member and the area where the curtain and drapes are secured to the cross-member.

### BRIEF DESCRIPTION OF THE DRAWINGS

FIG. 1 is a front elevational view of a modular partition decoration system according to one embodiment of the present invention (depicted along with a curtain and two drapes mounted between two vertical surfaces);

FIG. 2 is an exploded front view of the modular partition decoration system of FIG. 1;

FIG. 3 is a perspective view (from the bottom looking up) of the modular partition decoration system of FIG. 1 (shown along with a shower curtain rod);

FIG. 4 is a sectional front view of the modular partition decoration system of FIG. 1 (cut away along lines 4-4 in FIG. 3); and

FIG. 5 is a sectional side view of another embodiment of the invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

One embodiment of the present invention is directed to a modular partition decoration system comprising at least a first section and a second section. The two sections of this embodiment are arranged in an overlapping and telescoping manner with respect to one another, wherein the second section overlaps the first section. The sections may be further configured to at least partially conceal a cross-member that spans a distance between two opposing surfaces.

The system may further comprise a third section arranged in an overlapping and telescoping manner with respect, for example, to the second section (wherein the second section overlaps the third section in this example). The three sections may each comprise at least a front, top, and back. The front and/or back of the first section may contain one or more internally oriented attachment segments, such as, for example, hooks. Of course, the fronts and/or backs, for example, of the first and third sections may each have one or more internally oriented attachment segments.

In another example, for the system comprising three sections wherein each section has a front, top, and back, the first section may comprise a first side oriented generally orthogonally to at least one of the front, top, and back of that section. Additionally, the third section may comprise a second side which is also oriented generally orthogonally to at least one of the front, top, and back of that section. The first and/or second sides may each contain an internally oriented recess to facilitate positioning a cross-member therein. In another example, the first and/or second side may comprise an externally oriented friction layer that is adapted for contacting a respective surface of the two opposing surfaces.

In another example, for the system comprising at least a first section and a second section, the profiles of the first and second sections may each comprise three sides, and at least two of these three sides may be oriented generally orthogonally to the third.

In another example, for the system comprising at least a first section and a second section, the cross-member may be a rod (e.g., a shower curtain rod capable of supporting a shower curtain). The rod may facilitate holding the sections in position in between two opposing surfaces.

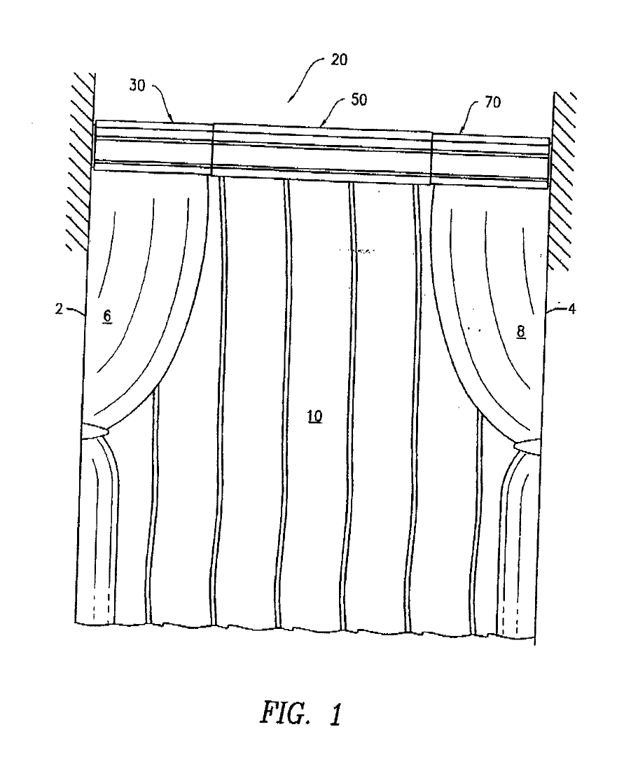

Referring now to FIG. 1, this FIG. depicts a modular partition decoration system according to an embodiment of the present invention, identified as cover 20. Cover 20 comprises (in one example) three sections referred to as a first end section 30, central section 50 and second end section 70. The cover 20 is depicted as oriented over, and thus concealing the top portions of a curtain 10 and accompanying first drape 6 and second drape 8 that are arranged and suspended in between two vertical sides, namely a first wall 2 and a second wall 4.

As will be discussed in more detail, below, the three sections 30, 50 and 70 of the cover 20 may be arranged to move telescopically relative to each other thereby facilitating the adjustability of the overall length of the cover 20 to enable it to fit various spans.

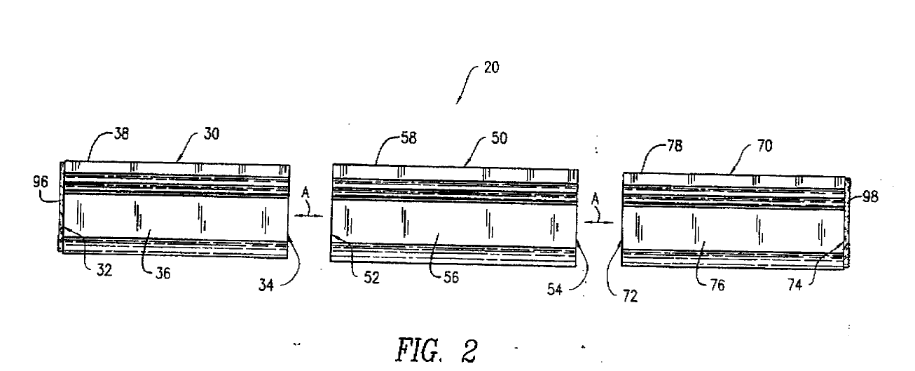

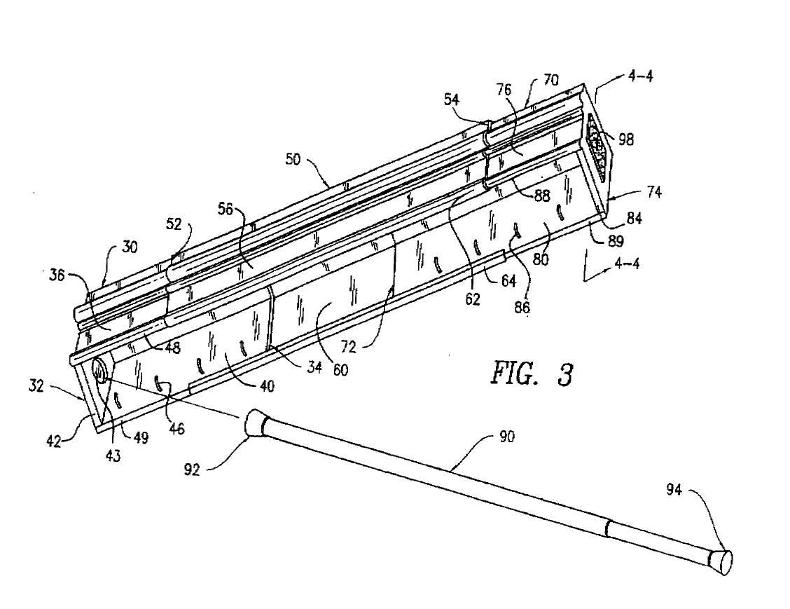

Referring to FIGS. 2 and 3, the three sections of the cover 20 are depicted (separately in FIG. 2 and in overlapping arrangement in FIG. in their respective orientations relative to each other. Generally, the first side section 30 comprises a first end 32 forming a side 42, a second open end 34 opposite the first end 32, a front 36, top 38, and back 40. The central section 50 comprises a first open end 52, a second open end 54, a front 56, top 58, and back 60. Further, the second side section 70 comprises a first open end 72, a second end 74 forming a side 84, a front 76, top 78, and back 80.

In one example, the central section 50 may be dimensioned slightly larger in cross-section than the first and second side sections 30 and 70 such that the first and second side sections 30 and 70 snugly fit inside, and are able to move telescopically relative to the central section 50. The assembly and subsequent movement of the first and second side sections 30 and 70 relative to the central section 50 is depicted by arrows A in FIG. 2.

More specifically, the second end 34 of the first side section 30 may be inserted into the first end 52 of the central section 50 such that the front 56, top 58, and back 60 of the central section 50 ride over the front 36, top 38, and back 40 of the first side section 30. Similarly, the first end 72 of the second side section 70 may be inserted into the second end 54 of the central section 50 such that the front 56, top 58, and back 60 of the central section 50 ride over the front 76, top 78, and back 80 of the second side section 70.

When assembled, the three sections 30, 50, and 70 form the cover 20 which may have telescoping ability, and an integral and ornamental appearance. The extent of the telescoping distance of the cover 20 is governed by the length of each section 30, 50, and 70 together with the amount of overlap between each of the first and second side sections 30 and 70 with the central section 50.

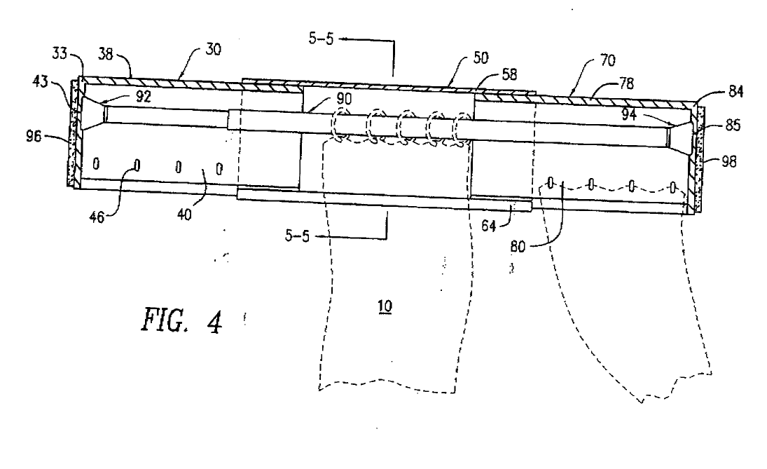

Reference is now made to FIGS. 1, 3 and 4, wherein FIG. 4 is a sectional view of the cover 20 taken along lines 4-4 in FIG. 3. In one example, a cross-member, such as rod 90, may be mounted between a first and second wall 2 and 4, and used to support a hanging curtain 10 (thus forming a partition). In this example, the cover 20 is configured to accept rod 90 within its hollow enclosure, thereby essentially concealing the rod 90 from view, as well as concealing the connection of the curtain 10 to the rod 90. The exteriors of the fronts 36, 56, and 76 of the three sections 30, 50 and 70 of the cover 20 may have ornamental shapes such that they provide further decoration and styling to the overall partition (while not hindering the telescoping ability of the cover 20). The exteriors of the backs 40, 60, and 80 of the three sections 30, 50, and 70 may also (or instead) have ornamental shapes or features, and these may be the same or different from the ones on the exteriors of the fronts.

In one example, to facilitate installation of the cover 20 and rod 90, sides 42 and 84 may contain recesses 43 and 85, respectively, that accommodate and help seat the rod 90 inside the cover 20. Once the first end 92 of the rod 90 is seated in recess 43 and the second end 94 of the rod 90 is seated in recess 85, the rod 90 is expanded inside the cover. Because the cover 20 of this example comprises three sections 30, 50, and 70 (which allow the cover 20 to telescope). the length of the cover 20 expands with the rod 90. The rod 90 is expanded until it exerts enough outward force on the opposing walls 2, 4 such that it will maintain its position, and consequently the position of the cover 20, between the walls 2, 4 through the consequent generation of frictional force (from the exertion of outward force on the walls 2, 4). At that point, the rod 90 is then locked in its expanded position, as is commonly known in the art, thus preventing it's contraction.

In another example, to help amplify the frictional forces holding the rod 90 and cover 20 in place, the cover 20 may be provided with friction pads, namely friction pad 96 on the first end 32 of the first side section 30, and friction pad 98 on the second end 74 of the second side section 70. These pads 96, 98 increase the coefficient of friction in the contact zone between the cover 20 and walls 2, 4, which therefore increases the frictional forces that hold the rod 90 and cover 20 in place.

In another example, the cover 20 may contain hooks to facilitate the hanging of additional ornamentation, such as drapes, to further decorate the partition. For example, as seen in FIGS. 3 through 5, a plurality of hooks 46 may be located on the interior of the back 40 of the first side section 30, and another plurality of hooks 86 may be located on the interior of the back 80 of the second side section 70. Similarly, a plurality of hooks 47 may be located on the interior of the front 36 of the first side section 30, and another plurality of hooks (not shown) may be located on the interior of the front 76 of the second side section 70. A first drape 6 may be supported from hooks 47 (or hooks 46) of first side section 30, and a second drape 8 may be supported from the hooks (not shown) on the front or back of second side section 70, as depicted in FIG. 1. Of course, any number of hooks and/or any other type of attachment segments or means for attachment may be employed, and any desirable article attached thereto, whether for ornamentation or otherwise.

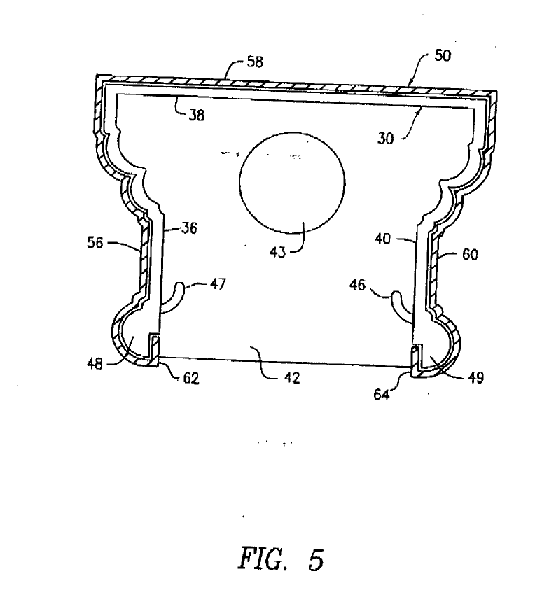

FIG. 5 depicts a sectional side view of another embodiment of the present invention. More specifically, FIG. 5 is a sectional side view of an embodiment of cover 20 referenced from lines 5-5 in FIG. 4 but having a different cross-sectional shape from the embodiment shown in FIG. 4. In the example depicted in FIG. 5, the cross-sectional shape, or profile, of the front 56 of the central section 50 is a mirror image of the profile of the back 60 of the central section 50. Similarly, in this example, the profile of the front 36 of the first side section 30 is a mirror image of the profile of the back 40 of the first side section 30. Additionally, the overall profile of the first side section 30 closely matches the overall profile of the central section 50, with the exception of the region of the rails 48, 49 of the first side section 30 and lips 62, 64 of the central section 50, which will discussed in more detail, below.

Any shapes and combination of profiles of the various fronts, tops, and backs of the sections of the cover 20 are contemplated, so long as there remains telescoping ability among the respective sections of the cover 20. The overall profiles of the sections may even be, for example, round or spheroidal, in which case the fronts, tops and backs of such sections that comprise the cover 20 are identified as those that generally face in the front, top, and back directions, respectively.

Of course, symmetrically shaped sections are readily interchangeable for use on either side of a partition. For example, if the first end section 30 and the second end section 70 of cover 20 are each symmetrically shaped, then they may be interchangeably used on either side of central section 50. This, of course, improves the cost-effectiveness of manufacturing, since only two different parts, rather than three, need to be manufactured. Additionally, it facilitates easier installation since each end section may be placed on either side of the central section.

It is further recognized that the shapes of the exteriors of any of the fronts, tops and backs of the sections of the cover may also be different from the shapes of the interiors of the same fronts, tops and backs. For example, with reference to FIG. 3, the interior of the front 36 of the first side section 30 may be flat, while the exterior of the front 36 of the first side section 30 is scalloped.

In another example, to facilitate improved structural integrity of the assembled cover 20, as well as performance of the cover 20 during it's expansion or contraction, the cover may be constructed with rails and corresponding communicating lips. More specifically, with reference to FIGS. 3 and 5, the first side section 30 may have a front rail 48 and back rail 49, the second side section 70 may also have a front rail 88 and back rail 89, and the central section 50 may have a corresponding front lip 62 and back lip 64. When the cover 20 is assembled, the rails 48, 49 of the first side section 30 are cooperatively arranged with the lips 62, 64 of the central section 50, and the rails 88, 89 of the second side section 70 are also cooperatively arranged with the lips 62, 64 of the central section 50. The rails 48, 49 and 88, 89 and lips 62, 64 behave as movement guides such that their interaction limits the freedom of movement of the first side section 30 and second side section 70 relative to the central section 50 to essentially only the longitudinal, or telescoping direction. Of course, any other shapes, quantities, and locations of the rails and lips may be utilized to achieve this purpose.

Further, cover 20 may be mounted in a span by any other means known in the art separately from that described herein. For example, the first end 32 of the first end section 30, and/or the second end 74 of the second end section 70 may have internally extending tabs that facilitate attaching the respective sections to walls using, for example, screws. As such, the cover 20 need not have sides 42 and 84.

Of course, the cover 20 is not limited to being comprised of three sections. It may be comprised of as little as two sections, and may also have more than three sections. A two section cover may simply comprise the first end section 30 and a central section 50 (which would be modified for use as an end section), while a cover having multiple sections may have them arranged in any telescoping order.

The material comprising the cover 20 may be any material suitable to accomplish the cover's purpose. In one example, if the cover 20 is not intended to be load-bearing such that it will not have hooks and will not support drapes for example, then it may be made from any commonly known thin, lightweight plastic material. A modular molding system designed in this manner is disclosed in U.S. Pat. No. 6,477,818 to Jensen, the entire disclosure of which is expressly incorporated by reference herein. Alternatively, the cover may be made from a relatively thin yet more structurally supportive material such as, for example, stainless steel. Such a cover may be more readily employed to support drapes, for example. Still further, the cover may be made from an array of materials, and/or combination of materials. For example, the first and second side sections 30, 70 may be constructed from a sturdy material capable of supporting hooks and drapes, while the central section 50 may be constructed from a thin, light weight, plastic material which would serve to reduce the overall weight of the cover 20, facilitate more cost-effective shipping, and also minimize the visibility of the overlap seams between the central and side sections.

While a number of embodiments of the present invention have been described, it is understood that these embodiments are illustrative only, and not restrictive, and that many modifications may become apparent to those of ordinary skill in the art. For example, any section may overlay any other section(s). Further, one or more sections may be interchangeable. Further still, any desired number of sections may be utilized. Further still, the various steps may be carried out in any desired order (and any desired steps may be added and any desired steps may be eliminated).

What is claimed is:

1. A modular partition system, comprising:
a first section; and
a second section;
wherein the first section is arranged in an overlapping and telescoping manner with respect to the second section; and
wherein the first section and the second section are configured to at least partially conceal a cross-member that spans a distance between a first end of the first section and a first end of the second section.

2. The system of claim 1, wherein the first section comprises a front, a top and a back and wherein the second section comprises a front, a top and a back.

3. The system of claim 2, wherein at least one of:
(a) an inner surface of the front of first section comprises at least one attachment member;
(b) an inner surface of the back of first section comprises at least one attachment member;
(c) an inner surface of the front of second section comprises at least one attachment member; and
(d) a inner surface of the back of second section comprises at least one attachment member.

4. The system of claim 3, wherein at least one of the attachment members comprises a hook.

5. The system of claim 2, wherein the first section further comprises a first side disposed adjacent the first end of the first section.

6. The system of claim 5, wherein the first side of the first section is oriented generally orthogonally to the front, the top and the back of the first section.

7. The system of claim 6, wherein the first side of the first section comprises an internally facing recess to receive therein an end of the cross-member.

8. The system of claim 6, wherein the first side of the first section comprises an externally facing friction element for contacting one of two surfaces between which the modular partition system is installed.

9. The system of claim 2, wherein the second section further comprises a first side disposed adjacent the first end of the second section.

10. The system of claim 9, wherein the first side of the second section is oriented generally orthogonally to the front, the top and the back of the second section.

11. The system of claim 10, wherein the first side of the second section comprises an internally facing recess to receive therein an end of the cross-member.

12. The system of claim 10, wherein the first side of the second section comprises an externally facing friction element for contacting one of two surfaces between which the modular partition system is installed.

13. The system of claim 2, wherein each of the front, the top and the back of the first section is generally orthogonal to one another and wherein each of the front, the top and the back of the second section is generally orthogonal to one another.

14. The system of claim 1, wherein the cross-member is a rod capable of supporting a curtain.

15. The system of claim 14, wherein the curtain is a shower-curtain.

16. The system of claim 1, wherein the first and second sections are held in place between two opposed surfaces by the cross-member.

17. A modular partition system, comprising:
at least a first side section, a center section, and a second side section;
wherein the first side section is arranged in an overlapping and telescoping manner with respect to the center section;
wherein the second side section is arranged in an overlapping and telescoping manner with respect to the center section; and
wherein the first side section, the second side section and the center section are configured to at least partially conceal a cross-member that spans a distance between a first e nd of the first side section and a first end of the second side section.

18. The system of claim 17, wherein the center section overlaps each of the first side section and the second side section.

19. The system of claim 17, wherein the center section is overlapped by each of the first side section and the second side section.

20. The system of claim 17, wherein the first side section comprises a front, a top and a back; wherein the second side section comprises a front, a top and a back; and wherein the center section comprises a front, a top and a back

21. The system of claim 17, wherein at least one of:
(a) an inner surface of the front of first side section comprises at least one attachment member;
(b) an inner surface of the back of first side section comprises at least one attachment member;
(c) an inner surface of the front of second side section comprises at least one attachment member; and
(d) a inner surface of the back of second side section comprises at least one attachment member.

22. The system of claim 21, wherein at least one of the attachment members comprises a hook.

23. A method of installing a modular partition system between two surfaces, comprising:
providing a partition structure comprising at least a first side section, a center section, and a second side section; wherein the first side section is arranged in an overlapping and telescoping manner with respect to the center section; wherein the second side section is arranged in an overlapping and telescoping manner with respect to the center section; and wherein the first side section, the second side section and the center section are configured to at least partially conceal a cross-member that spans a distance between a first end of the first side section and a first end of the second side section;
placing a cross-member within the partition structure such that the cross-member spans a distance between a first end of the first side section and a first end of the second side section; and
expanding the cross member to expand the partition structure such that the first end of the first side section contacts the first surface and the first end of the second side section contacts the second surface;
wherein the first side section, the second side section, and the center section are configured to at least partially conceal the cross-member that spans the distance between the first end of the first side section and the first end of the second side section.

24. The method of claim 23, wherein each of the first and second surfaces is a wall.

25. The method of claim 23, wherein the center section overlaps each of the first side section and the second side section.

26. The method of claim 23, wherein the center section is overlapped by each of the first side section and the second side section.
